(19) United States
(12) Patent Application Publication
(10) Pub. No.: US 2026/0140030 A1
(43) Pub. Date: May 21, 2026

(54) Water Droplet Bouncing Experiment System

(71) Applicant: Guizhou Power Grid Co., Ltd., Guiyang (CN)

(72) Inventors: Bo LI, Guiyang (CN); Jie BAI, Guiyang (CN); Yu WU, Guiyang (CN); Yuan YUAN, Guiyang (CN); Wei HUANG, Guiyang (CN); Xu DAI, Guiyang (CN)

(21) Appl. No.: 19/451,375

(22) Filed: Jan. 16, 2026

Related U.S. Application Data
(63) Continuation of application No. PCT/CN2024/139044, filed on Dec. 13, 2024.

(30) Foreign Application Priority Data
Jul. 3, 2024 (CN) 202410885117.6

(51) Int. Cl. G01N 11/02

(52) U.S. Cl. CPC G01N 11/02

(57) ABSTRACT

Disclosed in the present disclosure is a water droplet bouncing experiment system, belonging to the technical field of water droplet experiment devices. The water droplet bouncing experiment system includes: a support; and a dripping unit including a liquid storage tank, a balance tank, and a water drop pipe, where the water drop pipe is in communication with the liquid storage tank, and the water drop pipe is used for dropping liquid onto the cable; and a separator is slidably mounted in the balance tank, and movement of the separator is adjusted to control the water drop pipe to return water or drop a particular amount of water with a constant pressing force.

### CROSS-REFERENCE TO RELATED APPLICATIONS

The present application is a continuation of International Application No. PCT/CN2024/139044, filed on Dec. 13, 2024, which claims priority to Chinese Patent Application No. 202410885117.6, filed on Jul. 3, 2024, the entire disclosure of which is incorporated herein by reference.

### TECHNICAL FIELD

The present disclosure relates to the technical field of water droplet experiment devices, in particular to a water droplet bouncing experiment system.

### BACKGROUND

Freezing rain is the most severe form of icing on power transmission cables. Short periods of freezing rain can quickly form ice glaze continuously coating the surface of a wire, creating numerous icicles. This ultimately leads to excessive ice weight, causing a cable to sway and a tower to collapse.

The kinetic behavior of water droplets bouncing on a superhydrophobic surface at room temperature has been extensively studied and is mainly divided into three stages: diffusion, contraction, and rebound. The water droplets bounce off the superhydrophobic surface easily because a trapped air layer in a superhydrophobic substrate structure reduces a contact area between the water droplets and an underlying substrate. A superhydrophobic wire often operates at very low temperatures when performing its anti-icing function. A low-temperature and high-humidity environment is likely to render the anti-icing effect of the superhydrophobic structure ineffective. Thus, bouncing of impact droplets on the superhydrophobic surface becomes ineffective, which means that the anti-icing function of the superhydrophobic wire fails in freezing rain conditions. Consequently, it is particularly important to study the bouncing behavior of water droplets on superhydrophobic surfaces under outdoor icing conditions, that is, at low temperatures and high humidity.

When studying the bouncing behavior of water droplets on superhydrophobic surfaces, multiple sets of control experiments need to be conducted. The volume of each group of water droplets must be consistent in order to minimize experimental errors. It is worth noting that a common method is to apply a pressing force F to cause water in a bottle to drop out. When the bottle is full of water, a pressing force F1 applied causes the water to flow out of an outlet. When the water in the bottle is almost used up, a pressing force F2 applied causes the water to flow out of the outlet. The pressing forces F1 and F2 are not identical, that is, as the amount of water in the bottle decreases, the pressing force F changes continuously, and it is difficult to control the pressing force F. As a result, the traditional application of a changing pressing force F causes water droplets to be dropped, which is difficult to control and may lead to differences in the volumes of water droplets, thus causing experimental errors.

Furthermore, since the low-temperature outdoor environment needs to be simulated, if water remains in a water drop pipe for a long period of time, it may freeze, affecting the progress of the experiment.

### SUMMARY

An objective of the present part is to provide an overview of some aspects of examples of the present disclosure and a brief description of some preferred examples. Simplifications or omissions may be made in the present part as well as the abstract of the description and the title of invention of the present application, so as not to obscure the objective of the present part as well as the abstract of the description and the title of invention. However, such simplifications or omissions cannot be used to limit the scope of the present disclosure.

In view of the above and/or problems in the prior art, the present disclosure is provided.

Accordingly, a problem to be solved by the present disclosure is how to control a certain amount of water to be dropped and how to prevent the water from freezing in a water drop pipe.

In order to solve the above technical problem, the present disclosure provides the following technical solution: a water droplet bouncing experiment system includes: a support used for fixing a cable; and a dripping unit including a liquid storage tank arranged on the support, a balance tank arranged on a top of the liquid storage tank, and a water drop pipe arranged at a bottom of the liquid storage tank. The liquid storage tank is used for storing water. The water drop pipe is in communication with the liquid storage tank. The water drop pipe is used for dropping liquid onto the cable. A separator is slidably mounted in the balance tank. Movement of the separator is adjusted to control the water drop pipe to return water or drop a particular amount of water with a constant pressing force.

As a preferred solution of the water droplet bouncing experiment system, the separator divides an interior of the balance tank into a connecting chamber and a mixing chamber. The connecting chamber is in communication with the liquid storage tank through a first pipe. The mixing chamber is in communication with the liquid storage tank through a second pipe.

As a preferred solution of the water droplet bouncing experiment system, the separator includes a separation disc. A rotary column is rotatably mounted in the balance tank. A mounting hole is provided on the separation disc. The rotary column is inserted into the mounting hole. A spiral groove is provided on a circumferential wall of the rotary column. A bump is arranged on an inner circumferential wall of the mounting hole. The bump is adapted to moving in a contour direction of the spiral groove. The bump is in interference fit to the spiral groove.

As a preferred solution of the water droplet bouncing experiment system, a bottom of the rotary column is provided with a limit disc. A bottom of the limit disc is provided with a plurality of ratchet grooves. The plurality of ratchet grooves are uniformly arranged around a circumferential direction of the limit disc. The top of the liquid storage tank is elastically provided with an annular ratchet block. The annular ratchet block is adapted to being connected to the ratchet groove in a snap-fit manner.

As a preferred solution of the water droplet bouncing experiment system, the separator further includes a floating safety disc. The floating safety disc is arranged on one side of the separation disc away from the liquid storage tank. The floating safety disc is elastically connected to the separation disc.

As a preferred solution of the water droplet bouncing experiment system, the water drop pipe includes a cooling portion and a liquid outlet portion. The cooling portion has a thread shape. The liquid outlet portion is in communication with the cooling portion. The cooling portion is in communication with the liquid storage tank through a third pipe. The water in the liquid storage tank is dropped out through the third pipe, the cooling portion and the liquid outlet portion in sequence. The cooling portion is used for cooling the water flowing into the cooling portion.

As a preferred solution of the water droplet bouncing experiment system, the dripping unit further includes an air pump. The air pump is in communication with the mixing chamber through a fourth pipe. A fourth electromagnetic valve is arranged on the fourth pipe. The air pump is used for driving the separation disc to move towards the liquid storage tank. A distance between the separation disc and a liquid level of the water in the liquid storage tank is constant.

As a preferred solution of the water droplet bouncing experiment system, the water droplet bouncing experiment system further includes a pressing unit including an air cylinder. The air cylinder is arranged on the support. An output end of the air cylinder presses the liquid storage tank with a constant pressing force.

As a preferred solution of the water droplet bouncing experiment system, a first electromagnetic valve is arranged on the first pipe. A second electromagnetic valve is arranged on the second pipe. A third electromagnetic valve is arranged on the third pipe. The first electromagnetic valve, the second electromagnetic valve, the third electromagnetic valve and the fourth electromagnetic valve are switched on or off to switch the water drop pipe to return water or drop water with a constant pressing force.

As a preferred solution of the water droplet bouncing experiment system, the water droplet bouncing experiment system includes: a control module electrically connected to the air pump; a monitoring module electrically connected to the control module and used for photographing and capturing a bouncing process of water droplets falling on the cable; a heat preservation pipe arranged on the liquid storage tank and used for preserving heat of the water in the liquid storage tank; and an anti-icing cover covering the dripping unit.

The present disclosure has the beneficial effects as follows: by controlling the separator in the balance tank to descend, a distance between the separator and a liquid surface of the water is constant during dripping, that is, a same volume of water can be pressed out by using a constant force. Moreover, water in the water drop pipe can be prompted to return by using a pressure effect, such that freezing caused by stagnation is avoided.

### BRIEF DESCRIPTION OF DRAWINGS

In order to describe the technical solutions in examples of the present disclosure more clearly, the accompanying drawings required for describing the examples are briefly described below. Obviously, the accompanying drawings in the following description are merely some examples of the present disclosure. Those of ordinary skill in the art can also derive other accompanying drawings from these accompanying drawings without creative efforts. In the figures:

FIG. 1 is a use scenario diagram of a water droplet bouncing experiment system;

FIG. 2 is a structural diagram of a water drop unit of a water droplet bouncing experiment system;

FIG. 3 is a sectional view of a water drop unit of a water droplet bouncing experiment system;

FIG. 4 is a structural diagram of a separator of a water droplet bouncing experiment system; and

FIG. 5 is a schematic diagram of a relationship between components of a water droplet bouncing experiment system.

### DETAILED DESCRIPTION OF THE EMBODIMENTS

In order to make the above objectives, features, and advantages of the present disclosure clearer and more understandable, particular embodiments of the present disclosure will be described in detail below in conjunction with the accompanying drawings of the description.

In the following description, numerous concrete details are set forth in order to provide a thorough understanding of the present disclosure. However, the present disclosure may be implemented otherwise than as specifically described herein. Those skilled in the art can make similar developments without departing from the spirit of the present disclosure, and therefore the present disclosure is not to be limited by the specific examples disclosed below.

Secondly, reference herein to “an example” or “example” means a specific feature, structure, or characteristic that can be included in at least one embodiment of the present disclosure. The phase “in an example” at different places in the present description neither refers to the same example, nor is a separate or selective example mutually exclusive of other examples.

### Example 1

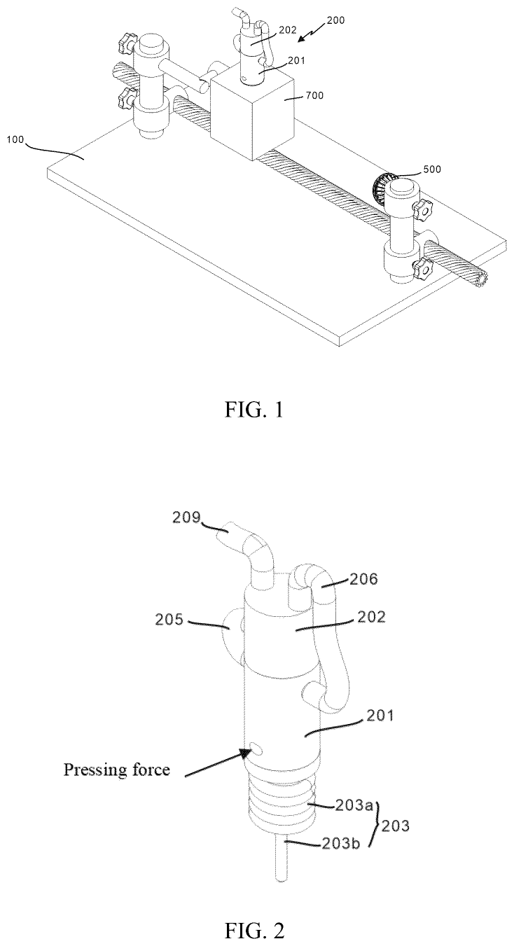

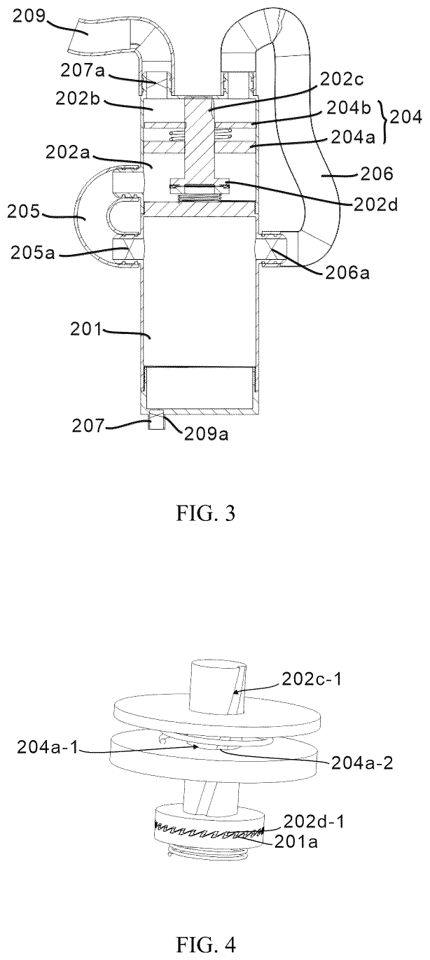

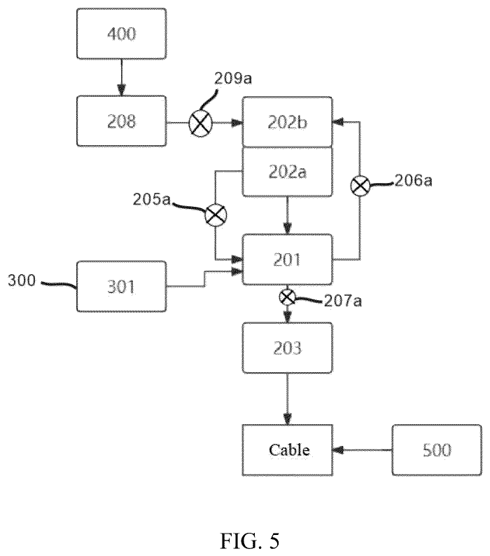

With reference to FIG. 1 to FIG. 5, a first example of the present disclosure is shown. The example provides a water droplet bouncing experiment system. The water droplet bouncing experiment system includes a support 100 and a dripping unit 200. The support 100 is used for fixing a cable and allowing the dripping unit 200 to be mounted. The dripping unit 200 is used for dropping liquid onto a surface of the cable.

It should be noted that an experimental environment of the water droplet bouncing experiment system is a simulated outdoor cold environment.

Specifically, the dripping unit 200 includes a liquid storage tank 201 arranged on the support 100, a balance tank 202 arranged at a top of the liquid storage tank 201, and a water drop pipe 203 arranged at a bottom of the liquid storage tank 201. The liquid storage tank 201 is used for storing water. The water drop pipe 203 is in communication with the liquid storage tank 201. Water in the liquid storage tank 201 may flow into the water drop pipe 203. The water drop pipe 203 is used for dropping liquid to the cable. The balance tank 202 is also in communication with the liquid storage tank 201. A separator 204 is slidably mounted in the balance tank 202. The separator 204 may slide in a length direction of the balance tank 202. Movement of the separator 204 is adjusted to control the water drop pipe 203 to return water to avoid that the water is frozen due to staying in the water drop pipe 203, or to drop a particular amount of water with a constant pressing force to guarantee that a volume of water dropped out is the same under one group of experiments, and then an experimental error is reduced.

Preferably, the separator 204 divides an interior of the balance tank 202 into a connecting chamber 202a and a mixing chamber 202b. The connecting chamber 202a is located below the mixing chamber 202b. The connecting chamber 202a is in communication with the liquid storage tank 201 through a first pipe 205. The mixing chamber 202b is in communication with the liquid storage tank 201 through a second pipe 206. During use, a chamber space of the connecting chamber 202a decreases continuously with decrease of a liquid level of the water in the liquid storage tank 201, while a chamber space of the mixing chamber 202b increases continuously with the decrease of the liquid level of the water in the liquid storage tank 201. The connecting chamber 202a and the mixing chamber 202b are not in communication with the liquid storage tank 201 at the same time.

Preferably, the separator 204 includes a separation disc 204a. Material of the separation disc 204a is rubber. A rotary column 202c is rotatably mounted in the balance tank 202. The rotary column 202c is arranged coaxial with the balance tank 202. A mounting hole 204a-1 is provided on the separation disc 204a. The rotary column 202c is inserted into the mounting hole 204a-1. A spiral groove 202c-1 is provided on a circumferential wall of the rotary column 202c. A bump 204a-2 is arranged on an inner circumferential wall of the mounting hole 204a-1. When the rotary column 202c rotates, the bump 204a-2 may move in a contour direction of the spiral groove 202c-1. The bump 204a-2 is in interference fit to the spiral groove 202c-1 to prevent air leakage at the spiral groove 202c-1.

Preferably, a bottom of the rotary column 202c is provided with a limit disc 202d. A bottom of the limit disc 202d is provided with a plurality of ratchet grooves 202d-1. The plurality of ratchet grooves 202d-1 are uniformly arranged around a circumferential direction of the limit disc 202d. The top of the liquid storage tank 201 is elastically provided with an annular ratchet block 201a. The annular ratchet block 201a is adapted to being connected to the ratchet groove 202d-1 in a snap-fit manner. When the rotary column 202c rotates and the separator 204 moves downwards, the limit disc 202d can rotate, and the annular ratchet block 201a is pressed to move vertically. In this case, the annular ratchet block 201a does not hinder rotation of the limit disc 202d, but the annular ratchet block 201a hinders rotation of the limit disc 202d in an opposite direction. That is, the separator 204 is restricted from moving upwards.

Preferably, the dripping unit 200 further includes an air pump 208. The air pump 208 is communication with the mixing chamber 202b through a fourth pipe 209. The air pump 208 may intermittently inject a certain amount of air into the mixing chamber 202b, to push the separation disc 204a to intermittently move downwards at a fixed distance. A fourth electromagnetic valve 209a is arranged on the fourth pipe 209. The fourth electromagnetic valve 209a is used for controlling the fourth pipeline 209 to be opened and closed. The air pump 208 is used for driving the separation disc 204a to move towards the liquid storage tank 201. That is, by intermittently injecting a certain amount of air into the mixing chamber 202b, the separation disc 204a is forced to move downwards, such that a distance between the separation disc 204a and the liquid level of the water in the liquid storage tank 201 is constant.

Preferably, the separator 204 further includes a floating safety disc 204b. The floating safety disc 204b is arranged on one side of the separation disc 204a away from the liquid storage tank 201. The floating safety disc 204b is elastically connected to the separation disc 204a. When the air pump 208 intermittently injects a certain amount of air into the mixing chamber 202b, thrust of the air needs to overcome an upward elastic force of the floating safety disc 204b to push the floating safety disc 204b and the separation disc 204a to move downwards, so as to play a safety role.

Preferably, a heat preservation pipe is arranged on the liquid storage tank 201. The heat preservation pipe is used for preserving a temperature of the water in the liquid storage tank 201, to maintain the temperature of the water in the liquid storage tank 201 above 0° C. and prevent the water from freezing in the liquid storage tank 201. The water drop pipe 203 includes a cooling portion 203a and a liquid outlet portion 203b. The cooling portion 203a has a thread shape, such that water in the cooling portion 203a is easier to cool. The liquid outlet portion 203b is in communication with the cooling portion 203a. The cooling portion 203a is communication with the liquid storage tank 201 through a third pipe 207. A third electromagnetic valve 207a is arranged on the third pipe 207. The third electromagnetic valve 207a is used for controlling the third pipe 207 to be opened and closed. The water in the liquid storage tank 201 is dropped out sequentially through the third pipe 207, the cooling portion 203a, and the liquid outlet portion 203b. The cooling portion 203a is used for cooling the water flowing into the cooling portion 203a.

Preferably, the water droplet bouncing experiment system further includes a pressing unit 300 including an air cylinder 301. The air cylinder is arranged on the support 100. An output end of the air cylinder 301 presses the liquid storage tank 201 with a constant pressing force.

It should be noted that when a maximum liquid height of the water in the liquid storage tank 201 is reached, maximum hydrostatic pressure at the bottom of the liquid storage tank 201 is also reached. The hydrostatic pressure decreases as the amount of water in the liquid storage tank 201 decreases. The pressing force exerted on the liquid storage tank 201 needs to be increased to press out the remaining water. In a case that the hydrostatic pressure is kept relatively constant, the water can be pressed with a relatively constant pressing force. The separation disc 204a descends as the liquid level of the water in the liquid storage tank 201 descends, and the distance between the separation disc 204a and the liquid level of the water in the liquid storage tank 201 remains relatively stable, such that pressure in the liquid storage tank 201 is forced to remain stable, and the hydrostatic pressure also keeps stable.

Further, a first electromagnetic valve 205a is arranged on the first pipe 205. The first electromagnetic valve 205a is used for controlling the first pipe 205 to be opened and closed. A second electromagnetic valve 206a is arranged on the second pipe 206. The second electromagnetic valve 206a is used for controlling the second pipe 206 to be opened and closed. The first electromagnetic valve 205a, the second electromagnetic valve 206a, the third electromagnetic valve 207a and the fourth electromagnetic valve 209a are switched on or off to switch the water drop pipe 203 to return water or drop water with a constant pressing force.

Further, the water droplet bouncing experiment system further includes: a control module 400, where the control module 400 is electrically connected to the air pump 208; a monitoring module 500 electrically connected to the control module 400, where the monitoring module 500 is used for photographing and capture a bouncing process of water droplets falling on the cable; and an anti-icing cover 700 covering the dripping unit 200.

In order to facilitate understanding of the technical solution of the present disclosure, a brief description of a working process of the technical solution is given below:

### Water Drop Stage

Step 1, the first electromagnetic valve 205a and the third electromagnetic valve 207a are turned on. The second electromagnetic valve 206a and the fourth electromagnetic valve 209a are turned off. The air cylinder 301 drives a pressing column 302 to press the liquid storage tank 201 with a constant pressing force. The water in the liquid storage tank 201 flows into the cooling portion 203a and is dropped out from the liquid outlet portion 203b.

Step 2, the first electromagnetic valve 205a is turned on. The second electromagnetic valve 206a, the third electromagnetic valve 207a and the fourth electromagnetic valve 209a are turned off. The air pump 208 injects a certain amount of air into the mixing chamber 202b. Thrust of the air overcomes the upward elastic force of the floating safety disc 204b to push the floating safety disc 204b and the separation disc 204a to move downwards, such that the separation disc 204a and the liquid level of the water in the liquid storage tank 201 remain relatively constant.

Step 3, step 1 is repeated to drip water.

### Water Return Stage

Step 1, the second electromagnetic valve 206a is turned on. The first electromagnetic valve 205a, the third electromagnetic valve 207a and the fourth electromagnetic valve 209a are turned off. The air cylinder 301 drives the pressing column 302 to press the liquid storage tank 201. The air in the liquid storage tank 201 enters the mixing chamber 202b. Then the second electromagnetic valve 206a is turned off.

It should be noted that after the air in the liquid storage tank 201 enters the mixing chamber 202b, pressure on the floating safety disc 204b cannot overcome the elastic force applied to the floating safety disc 204b, such that in this case, the separation disc 204a cannot be pushed downwards.

Step 2, the third electromagnetic valve 207a is turned on. The first electromagnetic valve 205a, the second electromagnetic valve 206a and the fourth electromagnetic valve 209a are turned off. In this case, the water in the water drop pipe 203 is returned to the liquid storage tank 201 under the action of atmospheric pressure.

The entire water return stage is sandwiched between step 1 and step 2 of the water drop stage to avoid freezing of the water in the water drop pipe 203.

It should be noted that the above examples are merely used to explain the technical solutions of the present disclosure and are not intended to limit the present disclosure. Although the present disclosure is described in detail with reference to the preferred examples, those of ordinary skill in the art should understand that they can make modifications or equivalent substitutions to the technical solutions of the present disclosure without departing from the spirit and scope of the technical solutions of the present disclosure. These modifications or equivalent substitutions should fall within the scope of the claims of the present disclosure.

What is claimed is:

1. A water droplet bouncing experiment system, comprising:
a support used for fixing a cable; and
a dripping unit comprising a liquid storage tank arranged on the support, a balance tank arranged at a top of the liquid storage tank, and a water drop pipe arranged at a bottom of the liquid storage tank, wherein the liquid storage tank is used for storing water, the water drop pipe is in communication with the liquid storage tank, and the water drop pipe is used for dropping liquid to the cable; and a separator is slidably mounted in the balance tank, and movement of the separator is adjusted to control the water drop pipe to return water or to drop a particular amount of water with a constant pressing force.

2. The water droplet bouncing experiment system according to claim 1, wherein the separator divides an interior of the balance tank into a connecting chamber and a mixing chamber, the connecting chamber is in communication with the liquid storage tank through a first pipe, and the mixing chamber is in communication with the liquid storage tank through a second pipe.

3. The water droplet bouncing experiment system according to claim 2, wherein the separator comprises a separation disc; and a rotary column is rotatably mounted in the balance tank, a mounting hole is provided on the separation disc, the rotary column is inserted into the mounting hole, a spiral groove is provided on a circumferential wall of the rotary column, a bump is arranged on an inner circumferential wall of the mounting hole, the bump is adapted to moving in a contour direction of the spiral groove, and the bump is in interference fit to the spiral groove.

4. The water droplet bouncing experiment system according to claim 3, wherein a bottom of the rotary column is provided with a limit disc, a bottom of the limit disc is provided with a plurality of ratchet grooves, the plurality of ratchet grooves are uniformly arranged around a circumferential direction of the limit disc, the top of the liquid storage tank is elastically provided with an annular ratchet block, and the annular ratchet block is adapted to being connected to the ratchet groove in a snap-fit manner.

5. The water droplet bouncing experiment system according to claim 4, wherein the separator further comprises a floating safety disc, the floating safety disc is arranged on one side of the separation disc away from the liquid storage tank, and the floating safety disc is elastically connected to the separation disc.

6. The water droplet bouncing experiment system according to claim 5, wherein the water drop pipe comprises a cooling portion and a liquid outlet portion, the cooling portion has a thread shape, and the liquid outlet portion is in communication with the cooling portion; the cooling portion is in communication with the liquid storage tank through a third pipe, and the water in the liquid storage tank is dropped out through the third pipe, the cooling portion and the liquid outlet portion in sequence; and the cooling portion is used for cooling the water flowing into the cooling portion.

7. The water droplet bouncing experiment system according to claim 6, wherein the dripping unit further comprises an air pump, the air pump is in communication with the mixing chamber through a fourth pipe, and a fourth electromagnetic valve is arranged on the fourth pipe; and the air pump is used for driving the separation disc to move towards the liquid storage tank, and a distance between the separation disc and a liquid level of the water in the liquid storage tank is constant.

8. The water droplet bouncing experiment system according to claim 7, further comprising a pressing unit comprising an air cylinder, wherein the air cylinder is arranged on the support, and an output end of the air cylinder presses the liquid storage tank with a constant pressing force.

9. The water droplet bouncing experiment system according to claim 7, wherein a first electromagnetic valve is arranged on the first pipe, a second electromagnetic valve is arranged on the second pipe, and a third electromagnetic valve is arranged on the third pipe; and the first electromagnetic valve, the second electromagnetic valve, the third electromagnetic valve and the fourth electromagnetic valve are switched on or off to switch the water drop pipe to return water or drop water with a constant pressing force.

10. The water droplet bouncing experiment system according to claim 8, comprising:
a control module electrically connected to the air pump;
a monitoring module electrically connected to the control module and used for photographing and capturing a bouncing process of water droplets falling on the cable;
a heat preservation pipe arranged on the liquid storage tank and used for preserving heat of the water in the liquid storage tank; and
an anti-icing cover covering the dripping unit.
